(19) United States
(12) Patent Application Publication
(10) Pub. No.: US 2014/0219708 A1
(43) Pub. Date: Aug. 7, 2014

(54) Articulating Attachment for Extension Poles

(71) Applicant: Justin Knight, Oceanside, CA (US)

(72) Inventor: Justin Knight, Oceanside, CA (US)

(21) Appl. No.: 14/075,735

(22) Filed: Nov. 8, 2013

Related U.S. Application Data
(60) Provisional application No. 61/724,206, filed on Nov. 8, 2012.

(51) Int. Cl. F16C 11/04

(52) U.S. Cl. CPC F16C 11/04
USPC 403/53

(57) ABSTRACT

An attachment for an extension poles, particularly for painter applications is disclosed. The device is designed to articulate and rotate about two or more axes to allow a painter to work at different angles. The device further provides novel structure allowing it to easily transition between engaged and unengaged positions. Ends of the device are configured to easily attach to an extension pole, paint brush, or roller brush, as applicable. In a preferred embodiment, the device is further telescoping, adding versatility.

### PRIORITY CLAIM

This patent application contains subject matter claiming benefit of the priority date of U.S. Prov. Pat. App. Ser. No. 61/724,206 filed on Nov. 8, 2012 and entitled, ARTICULATING ATTACHMENT FOR EXTENSION POLES; accordingly, the entire contents of these provisional applications are hereby expressly incorporated by reference.

### BACKGROUND OF THE INVENTION

1. Field of the Invention

The present invention pertains generally to tool positioning devices and systems. More particularly in a preferred embodiment, the invention relates to an articulating brush or tool holder attachment for an elongated pole device.

2. Description of the Prior Art

Extension poles particularly for painter applications have been known in the art. One such example is a patented device owned by The Wooster Brush Company and is entitled, “Quick Release Lock Mechanism for Handle Extensions,” U.S. Pat. No. 7,721,391. Additionally known are articulating holder devices for brushes or tools attachable to an extension pole. One such example was proposed by Franklin et al., entitled “Tool Positioning System,” U.S. Pat. App. Pub. No. 2010/0183362.

According to Franklin and his co-inventors, articulating joints known in the art permit a reversibly lockable positioning and repositioning a tool or brush within a useful range of operation. Further, it is often desirable to rotatably position and reposition a tool or brush, perhaps frequently. For example, when painting with a paint roller mounted to an extension pole, the roller is typically horizontal to the ground. It is often advantageous to change the position of the roller to permit painting in different directions, for example, by orientating the paint roller perpendicular to the ground.

Also as reported by Franklin et al., examples of moveable joints for connection components can be found in U.S. Pat. No. 5,123,768, awarded to Franklin on Jun. 23. 1992, which discloses, in part, a push-button adjustable jointed coupling for attaching paint rollers and the like. The drawback of U.S. Pat. No. 5,123,768 is that the apparatus utilizes a number of working metal parts, including a locking collar, set screw, cover plate, and two set screws on the cover plate; these components make the apparatus heavy and difficult to manufacture. U.S. Pat. No. 5,867,911 to Yates et al., discloses, in part, a two member apparatus with axially spaced teeth upon a first and second axially spaced button. U.S. Pat. No. 6,086,284 to Callahan discloses, in part, a lockable hub device having a base that accommodates a ganged pair of lockable attachment rings. U.S. Pat. No. 6,692,178, to Hsiu-E Yu, discloses, in part, a pivotable tool having a pair of interconnected arms disposed in a crossing relationship and having a manually releasable releasing device which locks the arms in a perpendicular open position for use as a wrench. U.S. Pat. No. 5,547,305 to Treche discloses, in part, a fastening subassembly for securing a hotstick component to another component or hotstick. U.S. Pat. No. 5,207,755 to Ampian, discloses, in part, a universally adjustable paint roller where the roller may be adjusted about three orthogonally disposed axes having a rotating mechanism coupled to an L-shaped member. U.S. Pat. No. 5,715,562 to Lowrey, et al. discloses, in part, a painting device with a pivotal adjustment frictionally held in place; the friction may be overcome by manual pressure to readjust joint position.

Additional prior art examples 91, 92, 93 of extension pole 99 attachment are illustrated in FIG. 1A through FIG. 1C. As shown particularly in FIG. 1C, two wing nuts 94, 95 provide rotational and angular adjustment to the paint brush 97 (via a clamp 96 covered in a vinyl sleeve 98). To insure rigidity the prior art device 93 requires that the wing nuts 94, 95 be torqued rather tightly requiring pliers for adjustment. This is particularly inconvenient for a user. Also, in the example of a relatively long extension pole 99 of twenty feet, a back and forth motion of the paint brush 97 will cause the wing nuts to loosen. When the wing nuts eventually become too loose, the painter will be required to stop work, lower the extension pole and retighten the wing nuts.

Accordingly, it is an object of the present invention to provide an attachment for an extension pool that more easily adjusts angularly and rotationally. It is an additional object of the invention to provide an attachment device that will remain rigid even after extended back and forth motion. Yet further, it is an object of the present invention to provide an articulating brush holder that can be adjusted by hand without additional tools.

### BRIEF SUMMARY OF THE INVENTION

The present invention specifically addresses and alleviates the above mentioned deficiencies associated with the prior art. More particularly, the present invention in a first aspect, is an accessory attachment for an elongated pole device comprising: a first adjoining member corresponding to an x-axis being rotatable about a z-axis; and a second adjoining member corresponding to an y-axis being rotatable about the z-axis, wherein the second aligning member is further rotatable about an own axis, wherein the own axis is the y-axis.

The present invention in this aspect is additionally characterized wherein the first member being rotatable about the z-axis comprises a thumb latch; and a fulcrum wherein the thumb latch transitions between an engaged position and an unengaged position about the fulcrum. Additionally further, the thumb latch unengaged position corresponds to the first and second adjoining members being rotatable about the z-axis, wherein the engaged position corresponding to the second and first adjoining members being fixed with regard to the z-axis.

More specifically in this embodiment, the fulcrum has a pin connector connecting the thumb latch to the first adjoining member. Also as explained further herein, the thumb latch is a first thumb latch wherein a second thumb latch is configured to the second adjoining member having engaged and unengaged positions, wherein the unengaged position allows the second adjoining member to rotate about its own axis.

The invention in this aspect is additionally characterized wherein the second thumb latch also has a pin connector configured as a fulcrum thereto, wherein the second adjoining member further comprises a plurality of apertures about a circumference thereof, the apertures assisting in the engaged and unengaged positions. Also according to the invention the accessory attachment includes: a male extension at a distal end of the second adjoining member; and a third thumb latch further configured at the distal end, wherein the male extension and the third thumb latch together are configured to receive a female handle on a roller cage device.

The invention in this aspect is further characterized as comprising a handle portion wherein the handle portion transitions between a substantially cylindrical body to a partially rectangular body. Still further, the first adjoining member comprises a pair of disks each having an aperture therein aligned with the z-axis, wherein the second adjoining member further has a disk having an aperture configured between said pair of disks. These said disks form a hinge about the z-axis. Still further, a first of the pair of disks comprises a carve out to accommodate the first thumb latch. In a preferred embodiment, a paint brush clamp is configured to a second adjoining member distal end.

These, as well as other advantages of the present invention will be more apparent from the following description and drawings. It is understood that changes in the specific structure shown and described may be made within the scope of the claims, without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A through FIG. 1C are illustrative of similar prior art devices;

FIG. 2 is a first perspective view of a preferred embodiment of the present invention;

FIG. 3 is a second perspective view of the first preferred embodiment from an opposite vantage point;

FIG. 4 is an enlarged view of the area bound by line 4-4 in FIG. 3;

FIG. 5 is an additional perspective view of the first preferred embodiment illustrating a device articulating as desired by a user; and

FIG. 6 is yet an additional perspective view of the present invention illustrating ends of the device.

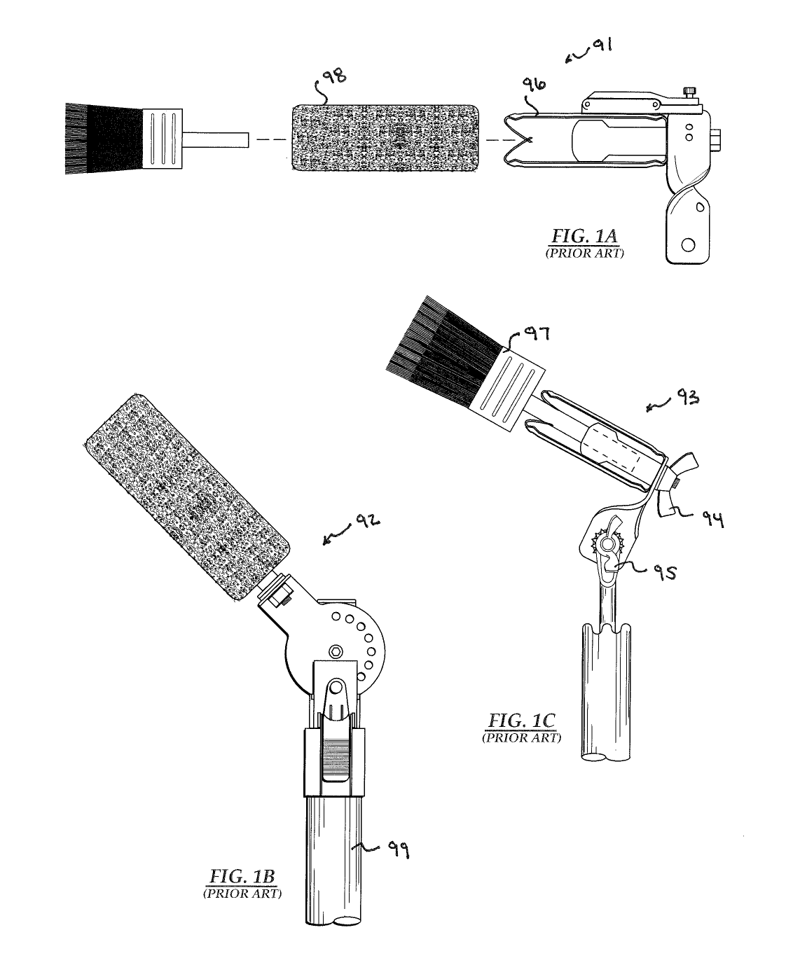

### DETAILED DESCRIPTION OF THE PREFERRED EMBODIMENTS

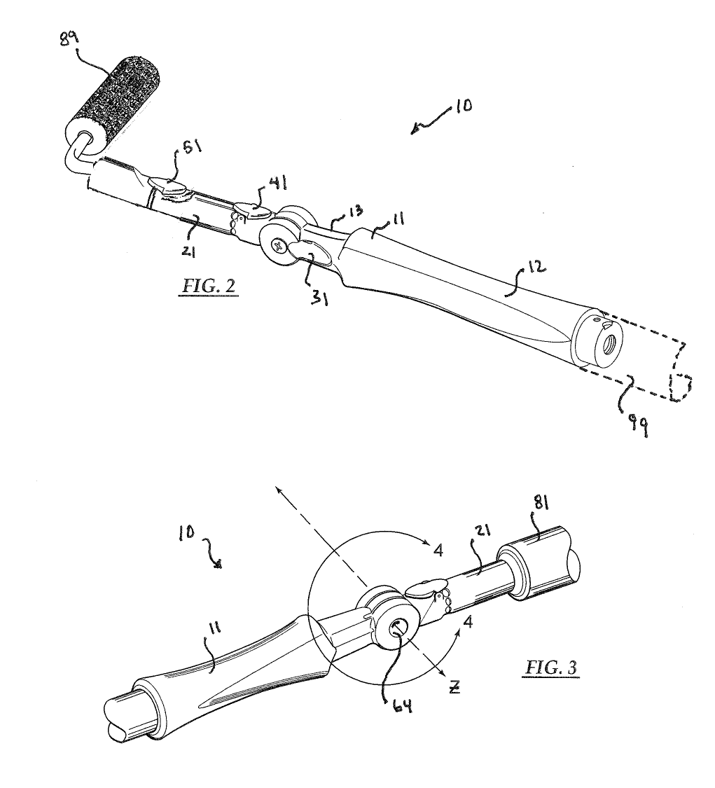

Various inventive features are described below that can each be used independently of one another or in combination with other features. Initially with regard to FIG. 2, a first preferred device 10 of the present invention is illustrated in perspective. In the most broad sense, the invention is directed to an accessory attachment 10 for an elongated pole device 99 allowing a user to align a tool 89 configured on an opposite end as necessitated by a particular job. More particularly with reference to FIG. 3 and FIG. 5, the invention provides a first adjoining member 11 corresponding to an x-axis being rotatable about a z-axis. Further, a second adjoining member 21 is provided corresponding to a y-axis being rotatable about a z-axis. Also as shown, the second adjoining member 21 is further rotatable about an own axis (y-axis) allowing for aligning and rotating a tool 89 as described herein.

More specifically regarding the first member being rotatable about the z-axis, a first thumb latch 31 is provided having a pin connector acting as fulcrum wherein the thumb latch transitions between an engaged position and an unengaged position about the fulcrum. Further, the unengaged position corresponds to the second adjoining member 21 being rotatable about the z-axis. Still further, the invention is characterized in that the engaged position corresponds to the second 21 and the first 11 adjoining members being fixed with regard to the z-axis.

In a preferred embodiment, a third thumb latch 51 is provided that connects to an existing roller brush (FIG. 2) according to the invention. However, in a slight variation as illustrated in FIG. 3, a fixed hollow member 81 is coupled to the second adjoining member. This fixed hollow member 81 will have a clamp 96 at an interior thereof; and additionally be configured so that a typical roller brush 89 can fit over the fixed member, as desired by a user.

As stated the fulcrum (for latch 31) comprises a pin connector connecting the first thumb latch 31 to the first adjoining member 11. Also more specifically, a second thumb latch 41 is configured to the second adjoining member 21 having engaged and unengaged positions, wherein the unengaged position allows the second adjoining member 21 to rotate about its own axis (y-axis, FIG. 5). The thumb latches 31, 41, 51 are relatively big buttons that are easy to engage and disengage and will not loosen with repeated back and forth movement providing stress to any connectors.

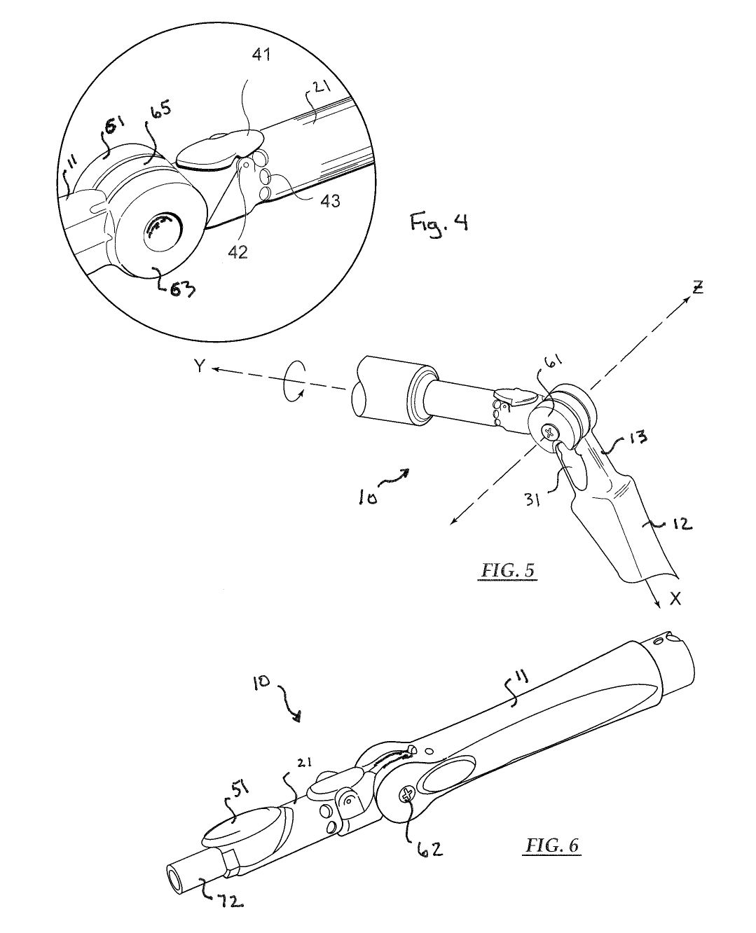

More particularly with regard to FIG. 4, an enlarged view of the second thumb latch 41 is provided. As with the first thumb latch 31, a fulcrum comprises a pin connector 42 to allow the thumb latch 41 to transition between engaged and unengaged positions. However different from the first thumb latch 31, a plurality of apertures 43 are provided circumscribing the second adjoining member 21. This configuration allows for the rotational aspects of invention 10 about the y-axis as shown.

The present invention in the preferred embodiment 10 is additionally characterized in that the first adjoining member 11 comprises a handle portion that transitions between a substantially cylindrical body 12 to a partially rectangular body 13. This design assists the engagement of the first thumb latch 31 and also allows for a smooth transition to a hinge 61, 63, 65 about the z-axis as further detailed herein.

With regard to FIG. 4, the accessory attachment 10 for an elongated pole device 99 herein is additionally characterized wherein the first adjoining member 11 includes a pair of disks 61, 63 each having an aperture 62, 64 therein aligned with the z-axis. Also, the second adjoining member 21 further has a disk 65 having an aperture (not shown) configured between said pair of disks 61, 63. The configuration 61, 62, 63, 64, 65 forms the aforementioned hinge about the z-axis. As shown, a screw is provided to complete the hinge.

Further with reference to FIG. 5, a first 61 of the pair of disks has a carve out to accommodate the first thumb latch 31. As described herein, the present invention 10 may also include a brush (or tool) clamp 96 configured to a second adjoining member distal end. A vinyl cover may also optionally be provided to the brush clamp 96. As illustrated in FIG. 6, a roller cage male extension 72 could be configured to the second adjoining member 21 distal end. Or an additional attachment has a clamp 96 to accommodate a paint brush. Yet still further according to the invention, the first 11 and second 21 adjoining members can be made telescoping or adjustable in length, thereby providing translational adjustment to the articulating and rotational properties.

Also according to alternative embodiments, a paint key or paint can opener may be coupled to the first adjoining member distal end. Additionally, an LED light may be configured to the second adjoining member while a battery compartment may be configured to either the first or second adjoining member. As another accessory to the invention, a box cutter type knife can be configured to either of the first or second joining member, pivotally secured at one end and housed by the battery compartment.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

While the particular Articulating Attachment for Extension Poles as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. An accessory attachment for an elongated pole device comprising:
a first adjoining member corresponding to an x-axis being rotatable about a z-axis;
a second adjoining member corresponding to an y-axis being rotatable about the z-axis, wherein the second aligning member is further rotatable about an own axis, wherein the own axis is the y-axis, and further wherein the first member being rotatable about the z-axis comprising:
a thumb latch; and
a fulcrum wherein the thumb latch transitions between an engaged position and an unengaged position about the fulcrum , further wherein the thumb latch unengaged position corresponding to the first and second adjoining members being rotatable about the z-axis, wherein the engaged position corresponding to the second and first adjoining members being fixed with regard to the z-axis.

2. The accessory attachment for an elongated pole device of claim 1 wherein the fulcrum comprises a pin connector connecting the thumb latch to the first adjoining member.

3. The accessory attachment for an elongated pole device of claim 1 wherein the thumb latch is a first thumb latch and further comprising a second thumb latch configured to the second adjoining member having engaged and unengaged positions, wherein the unengaged position allows the second adjoining member to rotate about its own axis.

4. The accessory attachment for an elongated pole device of claim 3, the second thumb latch further comprising a pin connector configured as a fulcrum thereto, wherein the second adjoining member further comprises a plurality of apertures about a circumference thereof, the plurality of apertures assisting in the engaged and unengaged positions.

5. The accessory attachment for an elongated pole device of claim 1, further comprising:
a male extension at a distal end of the second adjoining member; and
a third thumb latch further configured at the distal end, wherein the male extension and the third thumb latch together are configured to receive a female handle on a roller cage device.

6. The accessory attachment for an elongated pole device of claim 1, the first adjoining member comprising a handle portion wherein the handle portion transitions between a substantially cylindrical body to a partially rectangular body.

7. The accessory attachment for an elongated pole device of claim 1 the first adjoining member comprising a pair of disks each having an aperture therein aligned with the z-axis, wherein the second adjoining member further has a disk having an aperture configured between said pair of disks, and wherein said pair and said disk configured between form a hinge about the z-axis.

8. The accessory attachment for an elongated pole device of claim 7 wherein a first of the pair of disks comprises a carve out to accommodate the first thumb latch.

9. The accessory attachment for an elongated pole device of claim 1 further comprising a clamp configured to a second adjoining member distal end.
